(19) United States
(12) Patent Application Publication
(10) Pub. No.: US 2018/0272973 A1
(43) Pub. Date: Sep. 27, 2018

(54) EMERGENCY NOTIFICATION SYSTEM

(71) Applicant: MAZDA MOTOR CORPORATION, Hiroshima (JP)

(72) Inventors: Masahiro KOBAYASHI, Hiroshima-shi, Hiroshima (JP); Osamu TANAKA, Hiroshima-shi, Hiroshima (JP); Yoshinori AKASAKA, Aki-gun, Hiroshima (JP); Mitsuhiro YAMOTO, Higashihiroshima-shi, Hiroshima (JP); Masahiro SHIMOYAMA, Hiroshima-shi, Hiroshima (JP); Masanobu KOSAKA, Kure-shi, Hiroshima (JP); Kengo IWATA, Hiroshima-shi, Hiroshima (JP)

(73) Assignee: MAZDA MOTOR CORPORATION, Hiroshima (JP)

(21) Appl. No.: 15/763,234

(22) PCT Filed: Mar. 16, 2017
(86) PCT No.: PCT/JP2017/010672

§ 371 Date: Mar. 26, 2018

(30) Foreign Application Priority Data
Mar. 23, 2016 (JP) 2016-058876

(51) Int. Cl. B60R 21/00; H04M 11/04; G08B 25/10

(52) U.S. Cl. CPC B60R 21/00; H04M 11/04; B60R 2021/0104; B60R 2021/0027; G08B 25/10

(57) ABSTRACT

An emergency notification system comprises an emergency notification unit 10, an audio control unit 30, and a speaker drive unit 40 for driving a vehicle-mounted speaker 42 based on control by the audio control unit 30, wherein the emergency notification unit 10 comprises: a muting control section 21 operable, upon receiving a vehicle emergency signal, to transmit, to the audio control unit 30, a muting request signal B for muting the vehicle-mounted speaker 42, and to receive, from the audio control unit 30, a muting confirmation signal E indicating that the vehicle-mounted speaker 42 has been muted based on the muting request signal B; and a power supply control section 23 operable, when the muting control section 21 fails to receive the muting confirmation signal E in response to the transmission of the muting request signal B, to shut off supply of electric power to the speaker drive unit 40.

### TECHNICAL FIELD

The present invention relates to an emergency notification system, and more particularly to an emergency notification system for performing a notification from a vehicle to the outside in the event of a vehicle emergency.

### BACKGROUND ART

Heretofore, there has been known an emergency notification system for performing an emergency notification from a vehicle to a specific emergency notification center, in the event of an emergency such as vehicle collision, or poor physical conditions of a vehicle occupant (see the following Patent Document 1). This emergency notification system is configured to establish a communication link with respect to the emergency notification center in the event of the emergency, to transmit data regarding current location information, vehicle identification information and others to the emergency notification center, and enable a call (phone conversation) between a vehicle occupant and an operator in the emergency notification center.

Further, in view of the risk that audio such as music output from a vehicle-mounted speaker hinders the phone conversation between the vehicle occupant and the operator, the emergency notification system described in the Patent Document 1 is configured to inhibit the audio output or turn down an audio volume from the vehicle-mounted speaker during the emergency call. Specifically, the emergency notification system is configured such that when an emergency notification unit thereof receives an airbag development signal (vehicle emergency signal) from an airbag device in the event of an emergency, the emergency notification unit outputs a muting request signal for inhibiting the audio output, to an vehicle-mounted audio device via CAN (in-vehicle LAN). Then, the vehicle-mounted audio device operates to inhibit or suppress the audio output from the vehicle-mounted speaker based on the received muting request signal.

### PRIOR ART REFERENCE

### Patent Document

Patent Document 1: JP 2009-290789A

### SUMMARY OF THE INVENTION

### Problems to be solved by the Invention

However, in the event of the emergency, there is a possibility that a problem such as a disconnection of the in-vehicle communication line (CAN) occurs. In this case, even if the emergency notification unit transmits the muting request signal, it becomes impossible to inhibit or suppress the audio output from the vehicle-mounted speaker. There is another possibility that a disconnection of wiring of the vehicle-mounted audio device occurs and the disconnected wiring gets in contact with a vehicle body or the like. This is likely to cause a situation where loud noise is generated from the vehicle-mounted speaker.

Therefore, with a view to reliably muting the vehicle-mounted speaker in the event of an emergency, the inventors of the present invention invented an emergency notification system in which that the emergency notification unit is configured to forcibly shut off supply of electric power to a speaker drive unit (amplifier unit) constituting the vehicle-mounted audio device. That is, shutting off the supply of electric power to the speaker drive unit as a means to directly drive the vehicle-mounted speaker is a reliable way to inhibit the audio output.

However, during the process of further research, the inventers found that the above configuration has the following problem although it is capable of reliably achieving the muting in the event of an emergency. Specifically, the vehicle-mounted audio device is generally configured such that, during a normal operation, an audio control unit transmits an audio signal to the speaker drive unit, and the speaker drive unit drives the vehicle-mounted speaker, while amplifying the received audio signal, to thereby generate an audio output from the vehicle-mounted speaker.

Further, the audio control unit is configured to regularly or irregularly communicate with the speaker drive unit to confirm status information of the speaker drive unit. Furthermore, the audio control unit is configured to store a failure code in an internal memory upon detecting abnormality in the status information. Thus, if the supply of electric power to the speaker drive unit is forcibly shut off in the event of an emergency, and thus the communication with the speaker drive unit is discontinued, the audio control unit will store some kind of failure code. However, what happened in this case is that the supply of electric power to the speaker drive unit was merely shut off, and therefore neither failure nor defect occurs in the audio control unit and the speaker drive unit.

This failure code continues to be stored in the audio control unit even after completion of the emergency notification, so that, in the case where diagnosis for failure of vehicle-mounted systems is performed in a periodic inspection or the like, the failure code stored in the audio control unit will be detected. In this case, as a way to cope with the detected failure code, the costly audio control unit or speaker drive unit can be replaced with a new one. As a result, the replacement of such a failure-free or defect-free component will cause a user to bear unnecessary maintenance expenses.

The present invention has been made in view of solving the above problem, and an object thereof is to provide an emergency notification system capable of, during an emergency notification, reliably muting an audio output hindering a phone conversation, and avoiding a determination of failure regarding component units of the system.

### Means for Solving Problems

In order to achieve the above object, the present invention provides an emergency notification system comprising: an emergency notification unit for performing an emergency notification to an emergency notification center, in response to generation of a vehicle emergency signal; an audio control unit connected to the emergency notification unit via an in-vehicle communication line; and a speaker drive unit communicably connected to the audio control unit to drive a vehicle-mounted speaker based on control by the audio control unit, wherein the emergency notification unit comprises: a muting control section configured, upon receiving the vehicle emergency signal, to transmit, to the audio control unit, a muting request signal for inhibiting or reducing an audio output of the vehicle-mounted speaker, and to receive, from the audio control unit, a muting confirmation signal indicating that the audio output of the vehicle-mounted speaker has been inhibited or reduced based on the muting request signal; and a power supply control section configured to shut off supply of electric power to the speaker drive unit if the muting control section fails to receive the muting confirmation signal in response to the transmission of the muting request signal.

In the emergency notification system of the present invention having the above feature, the emergency notification unit is operable, in response to the generation of the vehicle emergency signal, to transmit the muting request signal to the audio control unit so as to mute the vehicle-mounted speaker. Thus, in the present invention, in the event of a vehicle emergency, it is possible to mute the vehicle-mounted speaker under normal communication processing, without causing abnormality such as a state in which the communication between the audio control unit and the speaker drive unit is discontinued due to shut-off of the supply of electric power to the speaker drive unit, so that it is possible to avoid a risk that a determination of failure is made by these units.

On the other hand, in the present invention, if the muting control section fails to receive the muting confirmation signal from the audio control unit in response to the muting request signal transmitted by the muting control section, the power supply control section is operable to shut off supply of electric power to the speaker drive unit to mute the vehicle-mounted speaker. Thus, in the present invention, in the case where it is impossible to mute the vehicle-mounted speaker under the normal communication processing, e.g., due to occurrence of a defect in the in-vehicle communication line or the like, or determine whether or not the vehicle-mounted speaker is in a muted state, the supply of electric powder to the speaker drive unit can be forcibly shut off to reliably mute the vehicle-mounted speaker.

Preferably, in the emergency notification system of the present invention, the audio control unit is configured, based on the received muting request signal, to transmit, to the speaker drive unit, a muting instruction signal for inhibiting or reducing the audio output of the vehicle-mounted speaker, and, upon receiving, from the speaker drive unit, a signal indicating that the audio output of the vehicle-mounted speaker has been inhibited or reduced, to transmit the muting confirmation signal to the emergency notification unit.

According to this feature, the audio control unit is operable, in response to receiving of the muting request signal, to transmit the muting instruction signal to the speaker drive unit, so that it is possible to mute the vehicle-mounted speaker under the normal communication processing, and therefore avoid the risk that the determination of failure is made by the related units.

Preferably, the emergency notification system of the present invention, the power supply control section comprises an input switch connected to an electric power input line which is connected to the speaker drive unit, wherein the power supply control section is configured to switch the input switch to shut off the supply of electric power to the speaker drive unit.

According to this feature, the power supply control section is operable to switch the input switch so as to shut off the supply of electric power to the speaker drive unit, so that it is possible to reliably mute the vehicle-mounted speaker in the event of a vehicle emergency.

Preferably, in the emergency notification system of the present invention, the muting control section is configured to transmit the muting request signal plural times in response to the receiving of the vehicle emergency signal.

According to this feature, the muting control section is operable to transmit the muting request signal plural times. Thus, as long as no abnormality occurs in the in-vehicle communication line, the audio control unit can receive the muting request signal at a high possibility. Thus, in the event of a vehicle emergency, it is possible to increase a probability of muting the vehicle-mounted speaker under the normal communication processing.

Preferably, in the emergency notification system of the present invention, the power supply control section is configured to shut off the supply of electric power to the speaker drive unit if the muting control section fails to receive the muting confirmation signal within a given time period after the receiving of the vehicle emergency signal or the transmission of the muting request signal.

According to this feature, in the event of a vehicle emergency, assuming a situation where the in-vehicle communication line and the related units are normally operated, the muting of the vehicle-mounted speaker can be confirmed within the given time period. Thus, in this situation, there arises no need to shut off the supply of electric power to the speaker drive unit, so that it is possible to mute the vehicle-mounted speaker, without involving any determination of failure between the related units. On the other hand, assuming a situation where some kind of abnormality occurs in the vehicle due to vehicle collision or the like, there is a high possibility of failing to confirm the muting of the vehicle-mounted speaker within the given time period. In this situation, it is highly likely that the determination of failure has already been made due to the abnormality occurred, so that there is a low need to avoid the determination of failure between the related units due to the shut-off of the power supply. Thus, when failing to confirm the muting within the given time period, it is determined that some kind of abnormality occurs in the vehicle, and, based on this determination, the supply of electric power is forcibly shut off so as to mute the vehicle-mounted speaker muted quickly and reliably.

Preferably, in the emergency notification system of the present invention, the vehicle emergency signal includes a signal to be generated in response to detection of vehicle collision, or a signal to be generated in response to manipulation of a notification switch by a vehicle occupant.

According to this feature, in the event of not only a vehicle collision but also other emergencies such as sudden illness of a vehicle occupant, it is possible to stop the audio output from the vehicle-mounted speaker during the emergency notification.

### Effect of the Invention

The present invention can provide an emergency notification system capable of, during an emergency notification, reliably muting an audio output hindering a phone conversation, and avoiding a determination of failure regarding component units of the system.

### BRIEF DESCRIPTION OF DRAWINGS

FIG. 1 is an explanatory diagram of an emergency notification system according to one embodiment of the present invention.

FIG. 2 is an explanatory diagram depicting a configuration of the emergency notification system according to this embodiment.

FIG. 3 is a block diagram depicting an electric configuration of an emergency notification unit in this embodiment.

FIG. 4 is an explanatory diagram of muting processing and power supply shut-off processing in the emergency notification system according to this embodiment.

FIG. 5 is a chart depicting a processing flow of the muting processing and the power supply shut-off processing during automatic emergency notification in the emergency notification system according to this embodiment.

FIG. 6 is a chart depicting a processing flow of the muting processing and the power supply shut-off processing during manual emergency notification in the emergency notification system according to this embodiment.

FIG. 7 is an explanatory diagram of unmuting processing and power supply restoration processing in the emergency notification system according to this embodiment.

FIG. 8 is a chart depicting a processing flow of the unmuting processing and the power supply restoration processing after completion of emergency notification in the emergency notification system according to this embodiment.

### EMBODIMENTS

With reference to the accompanying drawings, the present invention will now be described based on one embodiment thereof.

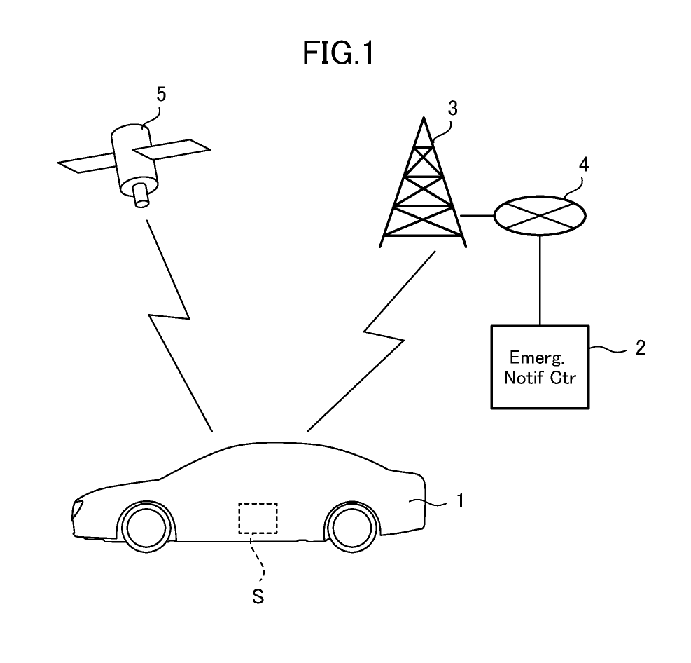

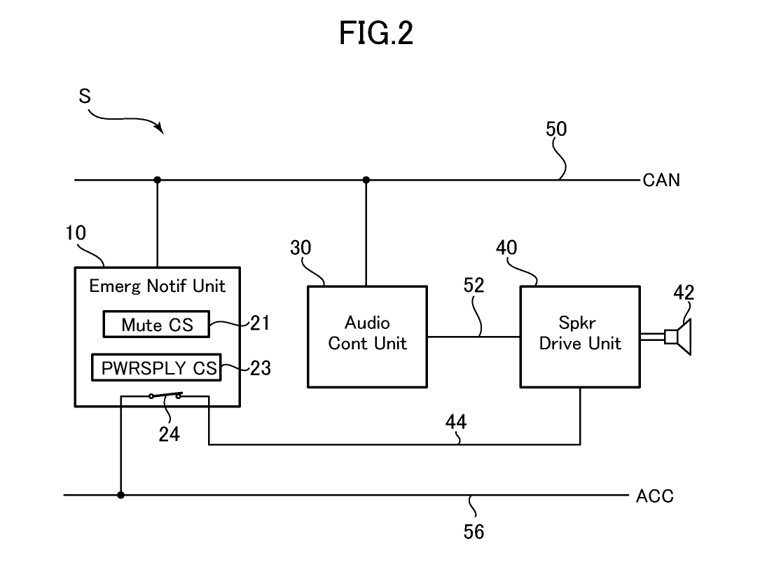

First of all, an outline of an emergency notification system according to one embodiment of the present invention will be described with reference to FIGS. 1 and 2. FIG. 1 is an explanatory diagram of the emergency notification system, and FIG. 2 is an explanatory diagram depicting a configuration of the emergency notification system.

As shown in FIG. 1, a vehicle 1 comprising an emergency notification system S is constructed such that, in the event of an emergency (such as vehicle collision, or sudden illness of a vehicle occupant), it is capable of establishing a communication link with an emergency notification center 2 via a base station 3 and a communication network 4. The vehicle 1 is configured to acquire current location information (information about a current location of the vehicle 1) using a GPS satellite 5, and transmit the data regarding the current location information, vehicle identification information and others, via the established communication link to the emergency notification center 2. Further, a voice call is enabled between a vehicle occupant and an operator in the emergency notification center 2. This makes it possible to quickly take necessary measures such as calling for ambulance, through the emergency notification center 2.

As shown in FIG. 2, the emergency notification system S comprises an emergency notification unit 10, an audio control unit 30, and a speaker drive unit 40 connected to a vehicle-mounted speaker 42.

The emergency notification unit 10 is configured, in the event of a vehicle emergency, to execute an emergency notification processing with respect to the emergency notification center 2. The audio control unit 30 is configured to output audio signals for a TV, a radio, a music medium, a navigation system or the like, to the speaker drive unit 40, and control the speaker drive unit 40 which is a so-called “audio-amplifier”. The speaker drive unit 40 is configured, based on a control signal from the audio control unit 30, to drive the vehicle-mounted speaker 42, while amplifying the received audio signal, to thereby generate an audio output from the vehicle-mounted speaker 42.

The emergency notification unit 10 and the audio control unit 30 are connected to an in-vehicle communication line 50 (e.g., CAN as in-vehicle LAN (Local Area Network)) in a mutually communicable manner. The audio control unit 30 and the speaker drive unit 40 are connected to each other via a separate sub-communication line 52 in a mutually communicable manner.

The emergency notification system S according to this embodiment is configured to execute muting processing and power supply shut-off processing for inhibiting or reducing an audio output from the vehicle-mounted speaker 42 hindering a phone conversation during execution of the emergency notification processing. For this purpose, the emergency notification unit 10 comprises a muting control section 21 and a power supply control section 23.

The muting control section 21 is configured, in response to a vehicle emergency signal, to execute the muting processing for muting the vehicle-mounted speaker 42 during execution of the emergency notification processing. The muting control section 21 is also configured, after completion of the emergency notification processing, to execute unmuting processing for unmuting the vehicle-mounted speaker 42.

The power supply control section 23 is configured, when it is unclear whether or not the vehicle-mounted speaker 42 is in the muted state, despite the execution of the muting processing by the muting control section 21, to execute power supply shut-off processing for shutting off supply of electric power to the speaker drive unit 40 as a means to directly drive the vehicle-mounted speaker 42. The power supply control section 23 is also configured, after completion of the emergency notification processing, to execute power supply restoration processing for restarting the supply of electric power to the vehicle-mounted speaker 42.

In this embodiment, the speaker drive unit 40 is configured to be powered on and activated when a speaker power supply input line 44 has a high potential. The speaker power supply input line 44 is connected to an ACC power supply line 56 via an input switch 24 in the emergency notification unit 10. The input switch 24 is normally maintained in a closed state. Thus, when electric power is supplied to the ACC power supply line 56 during start-up of the vehicle 1, the speaker power supply input line 44 has a high potential, so that the speaker drive unit 40 is activated.

On the other hand, the power supply control section 23 of the emergency notification unit 10 is configured, upon satisfaction of a given condition, to switch the input switch 24 from the closed state to an open state. When the input switch 24 is switched to the open state, the speaker power supply input line 44 has a low potential, i.e., the supply of electric power to the speaker drive unit 40 is shut off, so that the speaker drive unit 40 is deactivated.

In this embodiment, the speaker drive unit 40 may be configured to receive supply of electric power directly from the speaker power supply input line 44, or may comprise an internal switch configured to be operated when the speaker power supply input line 44 has the high potential, to enable the speaker drive unit 40 to be supplied with electric power from another power supply line.

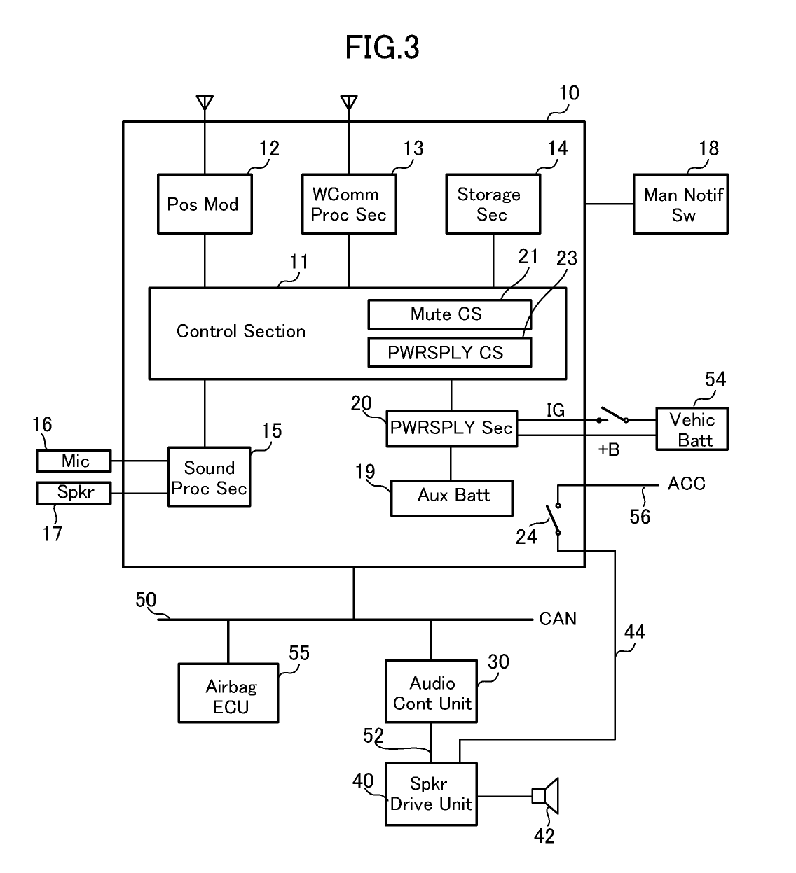

Next, with reference to FIG. 3, a configuration of the emergency notification unit in this embodiment will be described. FIG. 3 is a block diagram depicting an electric configuration of the emergency notification unit.

As shown in FIG. 3, the emergency notification unit 10 comprises a control section 11, a positioning module 12, a wireless communication processing section 13, a storage section 14, a sound processing section 15, a manual notification switch 18, an auxiliary battery 19, and a power supply section 20.

The control section 11 is composed, for example, of a CPU or the like, and is configured, in response to the vehicle emergency signal, to execute the emergency notification processing, the muting processing and others. The control section 11 functions as the muting control section 21 and the power supply control section 23.

The positioning module 12 is configured to receive a GPS signal from the GPS satellite 5 to acquire current location information. The wireless communication processing section 13 is configured to perform wireless communication (data communication and voice communication) with respect to the emergency notification center 2, via the base station and the the communication network 4. The storage section 14 stores therein information such as the vehicle identification information, and a communication address (phone number) of the emergency notification center 2.

The sound processing section 15 is connected to a microphone 16 and a speaker 17 each disposed inside the vehicle, and is configured to perform conversion processing between an audio signal and an electric signal when a vehicle occupant talks with an operator in the emergency notification center 2.

Assume a situation where, due to sudden illness of a vehicle occupant or the like, there arises a need to perform a notification to the emergency notification center 2. In this situation, the vehicle occupant can manipulate the manual notification switch 18 to input the vehicle emergency signal into the control section 11.

The auxiliary battery 19 is a primary battery, and is not used normally but used, only for a given period of time while an external power supply is lost, to function as a power supply for the emergency notification processing or the like, in place of the external power supply.

The power supply section 20 is connected to a vehicle battery 54 mounted on the vehicle 1, and is configured to normally receive supply of electric power from the vehicle battery 54, and supply a given electric power to the control section 11, the positioning module 12, the wireless communication processing section 13, the storage section 14, and the sound processing section 15, etc.

The emergency notification unit 10 is also connected to the in-vehicle communication line 50 via an interface circuit (not shown). Various ECUs in the vehicle 1 are connected to the in-vehicle communication line 50. Each of the ECUs is configured to transmit and receive communication data via the in-vehicle communication line 50. For example, an airbag ECU 55 is connected to the in-vehicle communication line 50.

The airbag ECU 55 comprises a vehicle collision sensor for detecting collision of the vehicle 1 using an acceleration sensor (not shown) and others, and is configured to develop an airbag in a given pattern upon detection of a vehicle collision. In this process, the airbag ECU 55 transmits a collision detection signal serving as the vehicle emergency signal, via the in-vehicle communication line 50. The emergency notification unit 10 is capable of reading the collision detection signal on the in-vehicle communication line 50, as the vehicle emergency signal.

The emergency notification unit 10 is configured to execute the emergency notification processing in response to the receiving of the vehicle emergency signal. Specifically, the control section 11 is configured to establish a communication link between the vehicle 1 and the emergency notification center 2 having the communication address stored in the storage section 14, via the wireless communication processing section 13, to transmit given data (current location information, vehicle identification information), and enable a voice call with respect to the emergency notification center 2. Then, for example, when the operator in the emergency notification center 2 on-hooks a telephone to disconnect the communication link, the emergency notification with respect to the emergency notification center 2 is terminated.

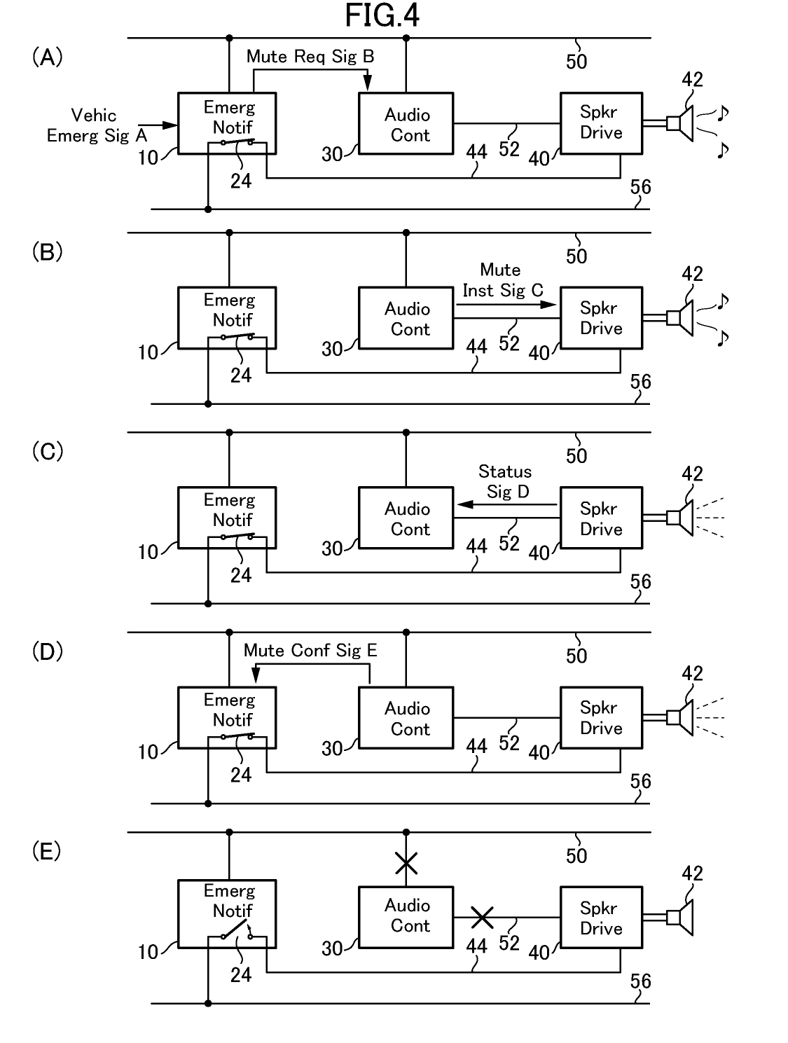

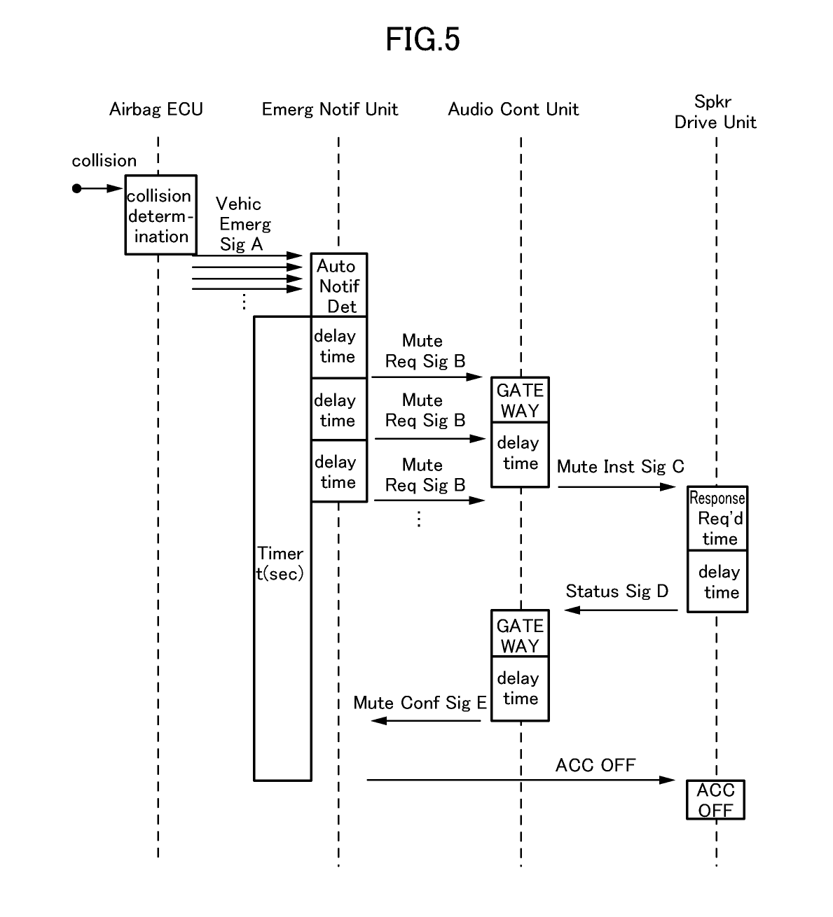

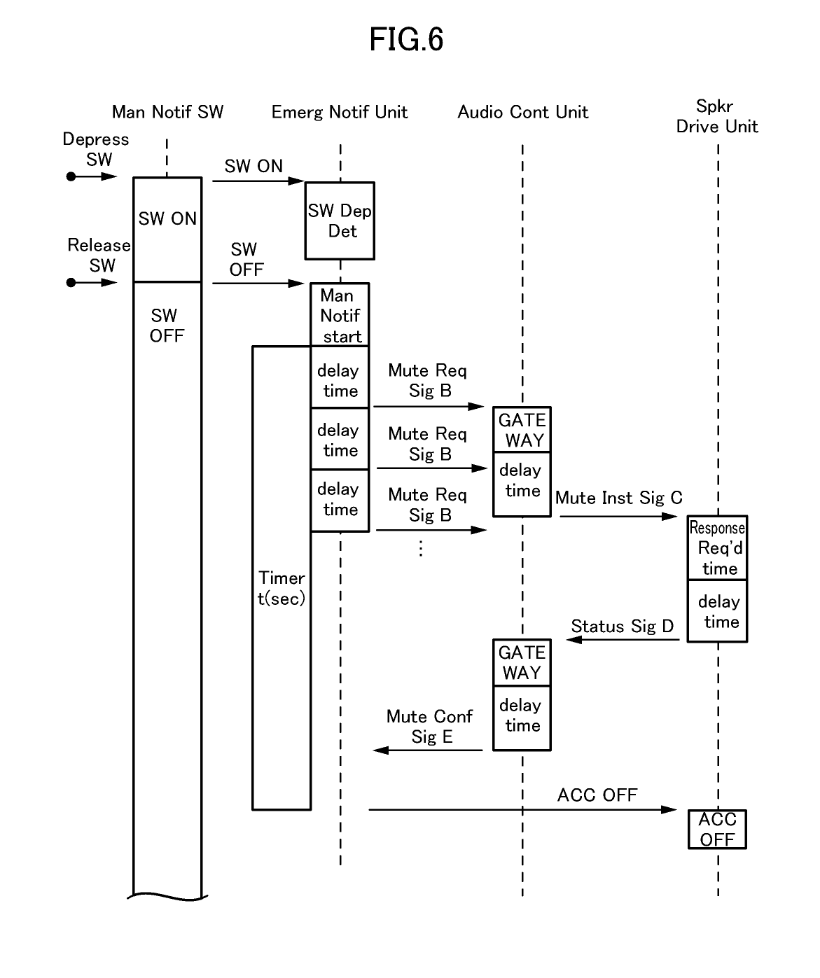

Next, with reference to FIGS. 4 to 6, the muting processing and the power supply shut-off processing in the emergency notification system according to this embodiment will be described. FIG. 4 is an explanatory diagram of the muting processing and the power supply shut-off processing. FIG. 5 is a chart depicting a processing flow of the muting processing and the power supply shut-off processing during automatic emergency notification, and FIG. 6 is a chart depicting a processing flow of the muting processing and the power supply shut-off processing during manual emergency notification.

In FIG. 4, for example, assume a situation where, when a vehicle occupant is listening to music from the vehicle-mounted speaker 42, while manipulating the audio control unit 30 during traveling of the vehicle, the vehicle emergency signal is input into the emergency notification unit 10 in response to detection of a vehicle collision (see FIG. 5) or manipulation of the manual notification switch 18 (see FIG. 6).

In the case of the automatic emergency notification shown in FIG. 5, the airbag ECU 55 performs a collision determination processing, based on a detection signal of the vehicle collision detection sensor. As a result, when determining the collision of the vehicle 1, the airbag ECU 55 transmits the vehicle emergency signal A via the in-vehicle communication line 50. In this process, the airbag ECU 55 successively transmits the vehicle emergency signal A plural times over several seconds.

Upon receiving any of the vehicle emergency signals A transmitted plural times, the emergency notification unit 10 executes automatic notification determination processing. That is, it is determined whether or not a signal received by the emergency notification unit 10 is the vehicle emergency signal A. As a result of the automatic notification determination processing, when the received signal is determined to be the vehicle emergency signal A, the emergency notification unit 10 starts processing such as the emergency notification processing.

On the other hand, in the case of the manual emergency notification shown in FIG. 6, when a vehicle occupant depresses the manual notification switch 18, a switch-ON signal indicative of depression of the manual notification switch 18 is output to the emergency notification unit 10. Based on the switch-ON signal, the emergency notification unit 10 executes switch depression determination processing. Specifically, in order to prevent execution of the emergency notification processing when the switch is erroneously depressed, in the switch depression determination processing, it is determined whether or not the switch is depressed for a given time period or more (e.g., 200 msec or more). Then, when the vehicle occupant releases the manual notification switch 18 after the elapse of the given time period, a switch-OFF signal indicative of release of the depression of the manual notification switch 18 is output to the emergency notification unit 10.

In this embodiment, the manual notification switch 18 is composed of a momentary switch configured to be always biased toward a normal position. That is, the manual notification switch 18 is configured to output the switch-ON signal only during a period in which the vehicle occupant pushes the manual notification switch 18 against the biasing force with his/her finger. Thus, upon release of the finger, the manipulation is terminated, and the manual notification switch 18 is returned to the normal position by the biasing force. Thus, in a normal state in which the manual notification switch 18 is not depressed, the switch-OFF signal is output to the emergency notification unit 10.

Assume that, in the switch depression determination processing, the switch-ON signal is determined to have been input for the given time period or more. In this case, when the switch-OFF signal is input after the determination, the emergency notification unit 10 performs manual notification start processing, wherein the switch-OFF signal is regarded as the vehicle emergency signal A to start the emergency notification processing and others. That is, in the case of the manual emergency notification, the switch-OFF signal (or, a change from the switch-ON signal to the switch-OFF signal) is equivalent to the vehicle emergency signal A. Alternatively, the input of the switch-ON signal based on depression of the manual notification switch 18 may be regarded as receiving of the vehicle emergency signal A.

As shown in FIG. 4(A), upon receiving the vehicle emergency signal A directly or via the in-vehicle communication line 50, the emergency notification unit 10 (muting control section 21) operates to transmit a muting request signal B indicative of a muting request with respect to the vehicle-mounted speaker 42, to the audio control unit 30 via the in-vehicle communication line 50. In this process, the emergency notification unit 10 operates to periodically transmit the muting request signal B plural times for a given maximum time t (e.g., t is 1 sec) after transmission of the initial muting request signal B until it receives a muting confirmation signal E (see FIGS. 5 and 6).

As shown in FIG. 4(B), upon receiving the muting request signal B, the audio control unit 30 operates to generate a muting instruction signal C indicative of an instruction for muting the vehicle-mounted speaker 42 (see “GATE WAY” in FIGS. 5 and 6), and transmit the muting instruction signal C to the speaker drive unit 40 via the sub-communication line 52 within a given delay time.

Upon receiving the muting instruction signal C, the speaker drive unit 40 operates to mute the vehicle-mounted speaker 42 by stopping output of the audio signal to the vehicle-mounted speaker 42 or by reducing an amplification factor of the audio signal or setting the factor to zero. As used in this specification, the term “muting” includes inhibiting any audio output of the vehicle-mounted speaker to provide a silent state, and reducing the audio output of the vehicle-mounted speaker to a given sound volume or less.

As shown in FIG. 4(C), after muting the vehicle-mounted speaker 42, the speaker drive unit 40 operates to transmit a status signal D indicating that the vehicle-mounted speaker 42 is in the muted state, to the audio control unit 30 via the sub-communication line 52, before the elapse of a processing time necessary for muting the vehicle-mounted speaker 42 since receiving of the muting instruction signal C, and a given delay time (see FIGS. 5 and 6). This status signal D is transmitted periodically or in response to the muting instruction signal C, and contains statuses of various operation parameters (sound volume, ON/OFF of muting, internal voltage value, positions of internal switches, etc.). In the status signal D shown in FIG. 4(C), the muting status is set to ON, because the vehicle-mounted speaker 42 is being muted.

As shown in FIG. 4(D), upon receiving the status signal D and confirming that the muting status in this signal is ON, the audio control unit 30 operates to generate a muting confirmation signal E indicating that the vehicle-mounted speaker 42 is in the muted state (see “GATE WAY” in FIGS. 5 and 6), and transmit the muting confirmation signal E to the emergency notification unit 10 via the in-vehicle communication line 50 within a given delay time.

In advance of starting the emergency notification processing, the emergency notification unit 10 (muting control section 21) can confirm that the vehicle-mounted speaker 42 is in the muted state, by receiving the muting confirmation signal E within a given time t (e.g., t is 1 sec) after receiving of the vehicle emergency signal A or transmission of the initial muting request signal B.

On the other hand, due to disconnection of the in-vehicle communication line 50 or the sub-communication line 52, or failure of the audio control unit 30 and/or the speaker drive unit 40, there is a possibility that the emergency notification unit 10 fails to receive the muting confirmation signal E within the given time t. In this situation, when the given time t has elapsed, the emergency notification unit 10 (power supply control section 23) operates to switch the input switch 24 from the closed state to the open state, as shown in FIG. 4(E) (power supply shut-off processing). As a result, the speaker power supply input line 44 has a low potential, so that the speaker drive unit 40 is deactivated (see “ACC OFF” in FIGS. 5 and 6). Then, due to the deactivation of the speaker drive unit 40, the vehicle-mounted speaker is muted.

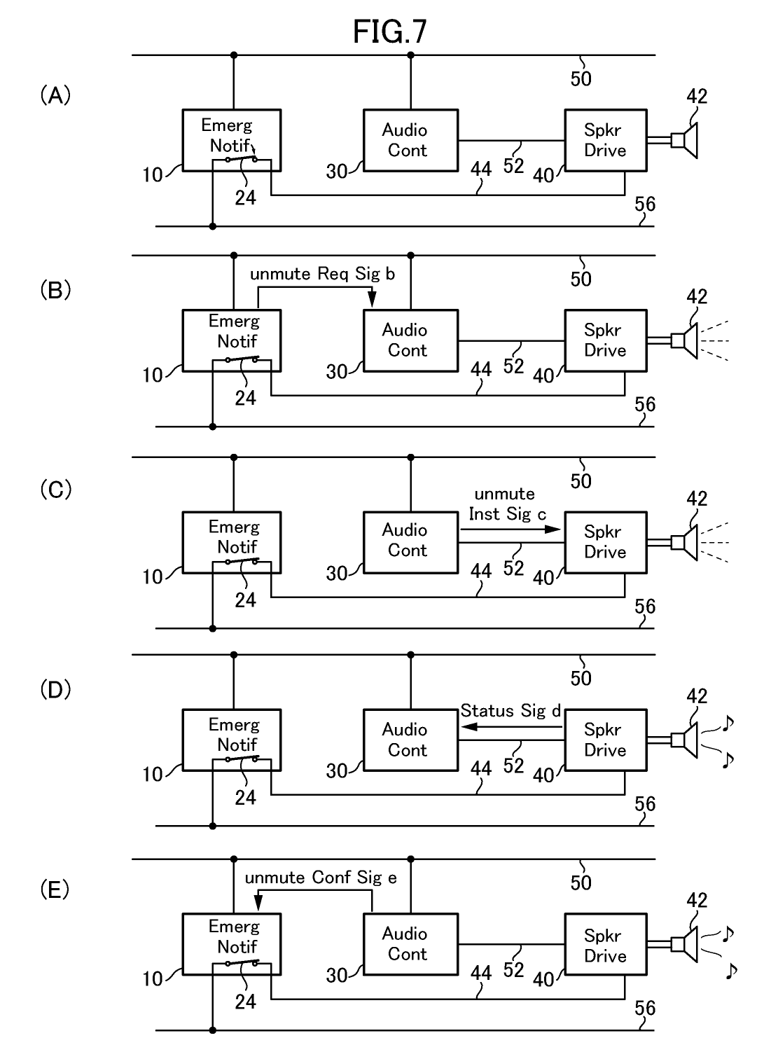

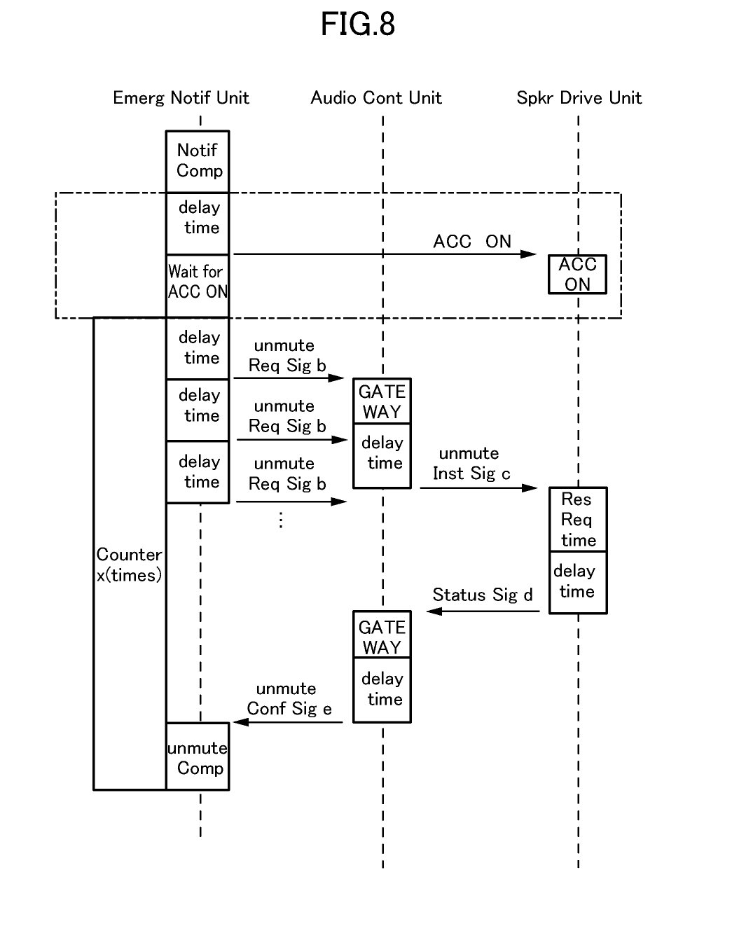

Next, with reference to FIGS. 7 and 8, unmuting processing and power supply restoration processing to be executed after completion of the emergency notification processing will be described. FIG. 7 is an explanatory diagram of the unmuting processing and the power supply restoration processing, and FIG. 8 is a chart depicting a processing flow of the unmuting processing and the power supply restoration processing.

As shown in FIG. 7(A), assume that, in the muting processing, the input switch 24 was switched to the open state (see FIG. 4(E)). In this case, after completion of the emergency notification processing, the emergency notification unit 10 (power supply control section 23) operates to return the input switch 24 to the closed state within a given delay time. As a result, the speaker drive unit 40 is powered on to start start-up processing (see “ACC ON” in FIG. 8). The emergency notification unit 10 waits for completion of the start-up processing of the speaker drive unit 40 for a given waiting time.

As shown in FIG. 7(B), in the case where, in the muting processing, the input switch 24 was not switched to the open state, and, after the muting processing, the input switch 24 has been returned to the closed state (see FIG. 7(A)), the emergency notification unit 10 (muting control section 21) operates to transmit an unmuting request signal b indicative of a request for unmuting the vehicle-mounted speaker 42, to the audio control unit 30 via the in-vehicle communication line 50. In this process, the emergency notification unit 10 operates to periodically transmit the unmuting request signal b given plural (x) times (e.g., x: 30 times) at a maximum, until receiving an unmuting confirmation signal e (see FIG. 8).

As shown in FIG. 7(C), upon receiving the unmuting request signal b, the audio control unit 30 operates to generate an unmuting instruction signal c indicative of an instruction for unmuting the vehicle-mounting speaker 42 (see “GATE WAY” in FIG. 8), and transmit the unmuting instruction signal c to the speaker drive unit 40 via the sub-communication line 52 within a given delay time.

Upon receiving the unmuting instruction signal c, the speaker drive unit 40 operates to drive or unmute the vehicle-mounted speaker 42 by restarting output of the audio signal to the vehicle-mounted speaker 42 or by restoring the amplification factor of the audio signal. As a result, the audio output of the vehicle-mounted speaker 42 is restarted.

As shown in FIG. 7(D), after unmuting the vehicle-mounted speaker 42, the speaker drive unit 40 operates to transmit a status signal d indicating that the vehicle-mounted speaker 42 is in an unmuted state, to the audio control unit 30 via the sub-communication line 52, before the elapse of a processing time necessary for unmuting the vehicle-mounted speaker 42 since receiving of the unmuting instruction signal c, and a given delay time (see FIG. 8). In this status signal d, the muting status is set to OFF, because the vehicle-mounted speaker 42 is being unmuted.

As shown in FIG. 7(E), upon receiving the status signal d and confirming that the muting status in this signal is OFF, the audio control unit 30 operates to generate a unmuting confirmation signal e indicating that the vehicle-mounted speaker 42 is in the unmuted state (see “GATE WAY” in FIG. 8), and transmit the unmuting confirmation signal e to the emergency notification unit 10 via the in-vehicle communication line 50 within a given delay time.

The emergency notification unit 10 (muting control section 21) can confirm that the vehicle-mounted speaker 42 is in the unmuted state, by receiving the unmuting confirmation signal e within a given time t (e.g., 2 sec) after completion of the emergency notification processing.

Next, functions/advantageous effects of the emergency notification system according to this embodiment will be described.

In this embodiment, the emergency notification unit 10 is operable, in response to the generation of the vehicle emergency signal A, to transmit the muting request signal B to the audio control unit 30 so as to mute the vehicle-mounted speaker 42. Thus, in this embodiment, in the event of a vehicle emergency, it is possible to mute the vehicle-mounted speaker 42 under normal communication processing, without causing abnormality such as a state in which the communication between the audio control unit 30 and the speaker drive unit 40 is discontinued due to shut-off of the supply of electric power, so that it is possible to avoid a risk that a determination of failure is made between these units.

On the other hand, in this embodiment, when the muting control section 21 fails to receive the muting confirmation signal E from the audio control unit 30 in response to the muting request signal B transmitted by the muting control section 21, the power supply control section 23 is operable to shut off supply of electric power to the speaker drive unit 40 to mute the vehicle-mounted speaker 42. Thus, in this embodiment, in the case where it is impossible to mute the vehicle-mounted speaker 42 under the normal communication processing, or determine whether or not the vehicle-mounted speaker 42 is in the muted state, e.g., due to occurrence of a defect in the in-vehicle communication line 50 or the like, the supply of electric powder to the speaker drive unit 40 can be forcibly shut off to reliably mute the vehicle-mounted speaker 42.

In this embodiment, the audio control unit 30 is operable, in response to receiving the muting request signal B, to transmit the muting instruction signal C to the speaker drive unit 40, so that it is possible to mute the vehicle-mounted speaker 42 under the normal communication processing, and therefore avoid the risk that the determination of failure is made between the related units 10, 30, 40.

In this embodiment, the power supply control section 23 is operable to switch the input switch 24 so as to shut off the supply of electric power to the speaker drive unit 40, so that it is possible to reliably mute the vehicle-mounted speaker 42 in the event of a vehicle emergency.

In this embodiment, the muting control section 21 is operable to transmit the muting request signal B plural times. Thus, as long as no abnormality occurs in the in-vehicle communication line 50, the audio control unit 30 can receive the muting request signal B at a high possibility. Thus, in this embodiment, in the event of a vehicle emergency, it is possible to increase a probability of muting the vehicle-mounted speaker 42 under the normal communication processing.

In this embodiment, in the event of a vehicle emergency, assuming a situation where the in-vehicle communication line 50 and the related units are normally operated, the muting of the vehicle-mounted speaker 42 can be confirmed within the given time period. Thus, in this situation, there arises no need to shut off the supply of electric power to the speaker drive unit 40, so that it is possible to mute the vehicle-mounted speaker 42, without involving any determination of failure between the related units. On the other hand, assuming a situation where some kind of abnormality occurs in the vehicle 1 due to vehicle collision or the like, there is a high possibility of failing to confirm the muting of the vehicle-mounted speaker 42 within the given time period. In this situation, it is highly likely that the determination of failure has already been made due to the abnormality occurred, so that there is a low need to avoid the determination of failure between the related units due to the shut-off of the power supply. Thus, when failing to confirm the muting within the given time period, it is determined that some kind of abnormality occurs in the vehicle, and, based on this determination, the supply of electric power is forcibly shut off so as to mute the vehicle-mounted speaker 42 muted quickly and reliably.

In this embodiment, in the event of not only a vehicle collision but also other emergencies such as sudden illness of a vehicle occupant, it is possible to stop the audio output from the vehicle-mounted speaker 42 during the emergency notification.

### EXPLANATION OF REFERENCE NUMERALS

1: vehicle
2: emergency notification center
3: base station
4: communication network
5: GPS satellite
10: emergency notification unit
11: control section
18: manual notification switch
21: muting control section
23: power supply control section
24: input switch
30: audio control unit
40: speaker drive unit
42: vehicle-mounted speaker
44: speaker power supply input line
50: in-vehicle communication line
52: sub-communication line
54: vehicle battery
55: airbag ECU
56: ACC power supply line
S: emergency notification system

1. An emergency notification system comprising:
an emergency notification unit for performing an emergency notification to an emergency notification center, in response to generation of a vehicle emergency signal;
an audio control unit connected to the emergency notification unit via an in-vehicle communication line; and
a speaker drive unit communicably connected to the audio control unit to drive a vehicle-mounted speaker based on control by the audio control unit,
wherein the emergency notification unit comprises:
a muting control section configured, upon receiving the vehicle emergency signal, to transmit, to the audio control unit, a muting request signal for inhibiting or reducing an audio output of the vehicle-mounted speaker, and to receive, from the audio control unit, a muting confirmation signal indicating that the audio output of the vehicle-mounted speaker has been inhibited or reduced based on the muting request signal; and
a power supply control section configured to shut off supply of electric power to the speaker drive unit if the muting control section fails to receive the muting confirmation signal in response to the transmission of the muting request signal.

2. The emergency notification system according to claim 1, wherein the audio control unit is configured, based on the received muting request signal, to transmit, to the speaker drive unit, a muting instruction signal for inhibiting or reducing the audio output of the vehicle-mounted speaker, and, upon receiving, from the speaker drive unit, a signal indicating that the audio output of the vehicle-mounted speaker has been inhibited or reduced, to transmit the muting confirmation signal to the emergency notification unit.

3. The emergency notification system according to claim 1, wherein the power supply control section comprises an input switch connected to an electric power input line which is connected to the speaker drive unit, and wherein the power supply control section is configured to switch the input switch to shut off the supply of electric power to the speaker drive unit.

4. The emergency notification system according to claim 1, wherein the muting control section is configured to transmit the muting request signal plural times in response to the receiving of the vehicle emergency signal.

5. The emergency notification system according to claim 1, wherein the power supply control section is configured to shut off the supply of electric power to the speaker drive unit if the muting control section fails to receive the muting confirmation signal within a given time period after the receiving of the vehicle emergency signal or the transmission of the muting request signal.

6. The emergency notification system according to claim 1, wherein the vehicle emergency signal includes a signal to be generated in response to detection of vehicle collision, or a signal to be generated in response to manipulation of a notification switch by a vehicle occupant.
